(19) United States
(12) Patent Application Publication
(10) Pub. No.: US 2015/0233554 A1
(43) Pub. Date: Aug. 20, 2015

(54) COMBINED LIGHT-EMITTING DIODE BULB

(71) Applicant: YAFERTECH CORP., GUANGDONG (CN)

(72) Inventor: Cheng-Wen Lin, New Taipei City (TW)

(21) Appl. No.: 14/420,813

(22) PCT Filed: Apr. 1, 2013
(86) PCT No.: PCT/CN2013/073567

§ 371 Date: Feb. 10, 2015

(30) Foreign Application Priority Data
Feb. 17, 2013 (CN) 201320073917.5

(51) Int. Cl. F21V 17/16; F21V 17/00; F21V 3/04; F21K 99/00; F21V 23/06

(52) U.S. Cl. CPC F21V 17/164; F21K 9/1355; F21V 23/06; F21V 3/04; F21V 17/002; F21Y 2101/02

(57) ABSTRACT

A combined LED bulb comprises a base body, a light source module detachably arranged at one end of the base body, a light-transmitting hood body detachably covering the same ends of both the base body and the light source module, and a connector detachably connected to the other end of the base body. Through modular design of the elements, the purpose of reducing element, decreasing procedures, improving capacity and yield of finished lamps, and lowering manufacturing cost and labor cost is realized; and the combined light-emitting diode bulb is applicable to a manual production line and an automatic production line at the same time.

### FIELD OF THE INVENTION

The present invention relates to a light-emitting diode (LED) light bulb, and in particular to a combined LED bulb.

### BACKGROUND OF THE INVENTION

In the contemporary LED lighting industry, an LED lamp generally comprises a lamp body, a lamp cover, a light source component, and a lamp head. The known process of assembling these components is complicated and takes a lot of labor-hours, making it consuming a large amount of time and money. Further, the assembling requires many operations, making it hard to increase the yield rate and unsuitable for automation and thus incapable of satisfying the need of mass production.

In view of the above, the present invention aims to provide a combined LED bulb, which allows for efficient and high-precision assembly of lights.

### SUMMARY OF THE INVENTION

The primary object of the present invention is to provide a combined light-emitting diode (LED) bulb that allows for modularization and fast assembly.

To achieve the above object, the present invention provides a combined light-emitting diode (LED) bulb, which comprises a base body, which has an end that comprises a first connection surface and an opposite end that comprises a second connection surface, wherein the first connection surface comprises a first module coupling section and a first cover coupling section arranged along a circumference of the first connection surface, the second connection surface comprising a first connector coupling section; a light source module, which is detachably mounted to the first connection surface and comprises an electric control substrate, a plurality of light-emitting diodes, two conductive pins, and a second module coupling section, wherein the light-emitting diodes are mounted to a surface of the electric control substrate the conductive pins are mounted to an opposite surface of the electric control substrate, the second module coupling section being arranged on the electric control substrate, the second module coupling section being detachably connectable the first module coupling section, the conductive pins extending through the base body to the second connection surface; a light-transmitting hood body, which is detachably mounted to the first connection surface of the base body to house the light source module in the light-transmitting hood body and comprises an opening and a second cover coupling section arranged along the opening, the second cover coupling section being detachably connectable the first cover coupling section; and a connector, which is detachably mounted to the second connection surface and comprises a conductor electrically connected to the conductive pins and a second connector coupling section, the second connector coupling section being detachably connectable to the first connector coupling section.

In the above-described combined LED bulb, the first module coupling section comprises snap barbs and the second module coupling section comprises snap slots.

In the above-described combined LED bulb, the first cover coupling section comprises snap slots and the second cover coupling section comprises snap barbs.

In the above-described combined LED bulb, the first connector coupling section comprises snap slots and the second connector coupling section comprises snap barbs.

In the above-described combined LED bulb, the light-transmitting hood body comprises a transparent light cover.

In the above-described combined LED bulb, the conductor a conductive shell that mates an outer configuration of the connector and is securely fit to the connector and comprises a screw thread.

In the above-described combined LED bulb, the conductor comprises a screw thread.

The efficacy of the present invention is to provide an LED bulb of efficient assembly.

### BRIEF DESCRIPTION OF THE DRAWINGS

The present invention will be apparent to those skilled in the art by reading the following description of preferred embodiments thereof with reference to the drawings, in which:

FIG. 1 is an exploded view showing a combined light-emitting diode (LED) bulb according to the present invention; and

FIG. 2 is a cross-sectional view showing the LED bulb according to the present invention in an assembled form.

### DETAILED DESCRIPTION OF THE PREFERRED EMBODIMENTS

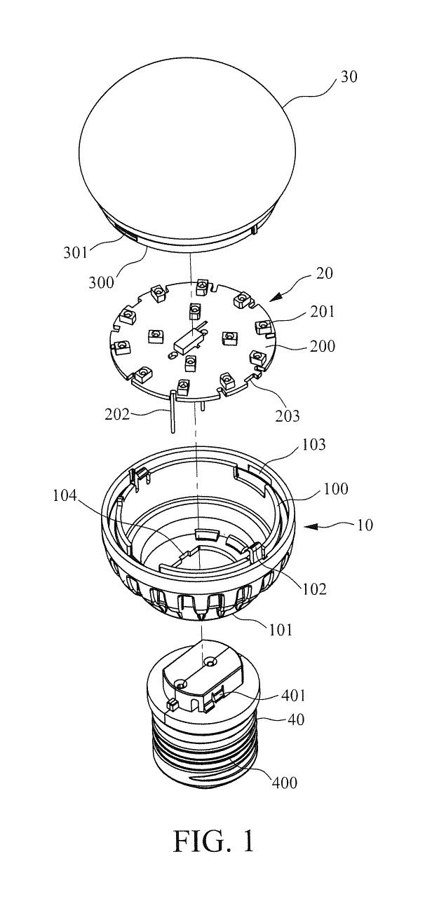

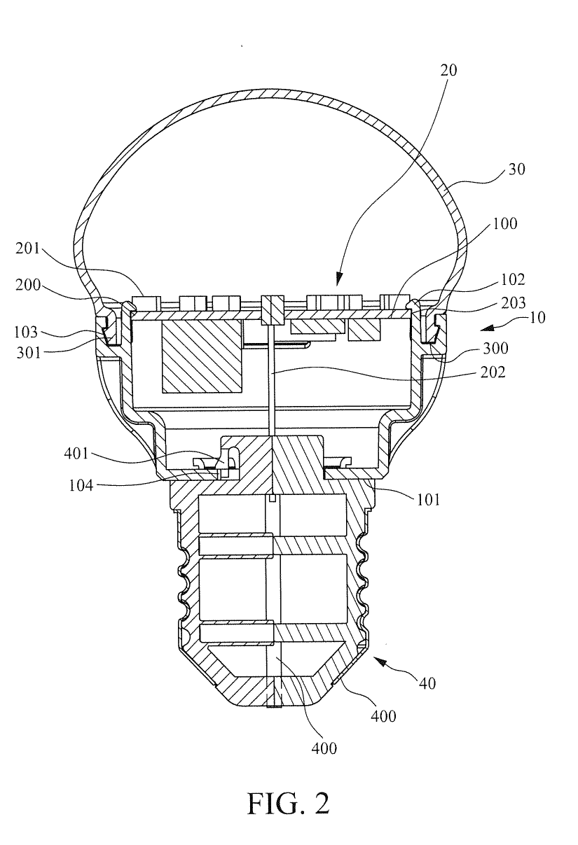

Referring to FIGS. 1 and 2, as shown in the drawings, in the instant embodiment, the present invention provides a combined light-emitting diode (LED) bulb, which comprises a base body 10, which has an end that comprises a first connection surface 100 and an opposite end that comprises a second connection surface 101, wherein the first connection surface 100 comprises a first module coupling section 102 and a first cover coupling section 103 arranged along a circumference of the first connection surface 100 and the second connection surface 101 comprises a first connector coupling section 104; a light source module 20, which is detachably mounted to the first connection surface 100 and comprises an electric control substrate 200, a plurality of light-emitting diodes 201, two conductive pins 202, and a second module coupling section 203, wherein the light-emitting diodes 201 are mounted to a surface of the electric control substrate 200; the conductive pins 202 are coupled to an opposite surface of the electric control substrate 200; the second module coupling section 203 is arranged along a circumference of the electric control substrate 200 and the second module coupling section 203 is detachably connectable to the first module coupling section 102, where in the instant embodiment, the first module coupling section 102 comprises snap barbs and the second module coupling section 203 comprises snap slots so that the conductive pins 202, after the light source module 20 and the base body 10 are connector to each other, extend through the base body 10 to reach to the second connection surface 101; a light-transmitting hood body 30, which is detachably mounted to the first connection surface 100 of the base body 10 to house the light source module 20 in the light-transmitting hood body 30 and comprises an opening 300 and a second cover coupling section 301 arranged along the opening, where the second cover coupling section 301 is detachably connectable to the first cover coupling section 103 and in the instant embodiment, the first cover coupling section 103 comprises snap slots and the second cover coupling section 301 comprises snap barbs and the light-transmitting hood body 30 is a transparent light cover; and a connector 40, which is detachably mounted to the second connection surface 101 and comprises a conductor 400 electrically connectable to the conductive pins 202 and a second connector coupling section 401, where the second connector coupling section 401 is detachably connectable to the first connector coupling section 104 and in the instant embodiment, the first connector coupling section 104 comprises snap slots and the second connector coupling section 401 comprises snap barbs and the conductor 400 is a conductive shell that mates the outer configuration of the connector 40 and is securely fit to the connector 40 and comprises a screw thread.

The above-described combined LED bulb enables combined assembly of the components through only three steps, which are step 1: the base body 10 being mounted to the light source module 20 through snap fitting; step 2: the base body 10 being mounted to the light-transmitting hood body 30 through snap fitting; and step 3: the base body 10 being mounted to the connector 40 through snap fitting to allow the conductor 400 to electrically engage the conductive pins 202 of the light source module 20. Through the combined design of the components, the purposes of reducing the number of parts, reducing assembling operations, increasing lamp production yield rate, reducing cost, and reducing labor cost can be achieved, and further, applications to manually operated production lines and automatized production lines are both possible so as to overcome the drawbacks of the known techniques.

Although the present invention has been described with reference to the preferred embodiments thereof, it is apparent to those skilled in the art that a variety of modifications and changes may be made without departing from the scope of the present invention which is intended to be defined by the appended claims.

1. A combined light-emitting diode (LED) bulb, characterized by comprising:
a base body, which has an end that comprises a first connection surface and an opposite end that comprises a second connection surface, wherein the first connection surface comprises a first module coupling section and a first cover coupling section arranged along a circumference of the first connection surface, the second connection surface comprising a first connector coupling section;
a light source module, which is releasably mounted to the first connection surface and comprises an electric control substrate, a plurality of light-emitting diodes, two conductive pins, and a second module coupling section, wherein the light-emitting diodes are mounted to a surface of the electric control substrate the conductive pins are mounted to an opposite surface of the electric control substrate, the second module coupling section being arranged on the electric control substrate, the second module coupling section being releasably connectable the first module coupling section, the conductive pins extending through the base body to the second connection surface;
a light-transmitting cover, which is releasably mounted to the first connection surface of the base body to house the light source module in the light-transmitting cover and comprises an opening and a second cover coupling section arranged along the opening, the second cover coupling section being releasably connectable the first cover coupling section; and
a connector, which is releasably mounted to the second connection surface and comprises a conductor electrically connected to the conductive pins and a second connector coupling section, the second connector coupling section being releasably connectable to the first connector coupling section, the first connector coupling section comprising snap slots, the second connector coupling section comprising snap barbs.

2. The combined LED bulb according to claim 1, characterized in that the first module coupling section comprises snap barbs and the second module coupling section comprises snap slots.

3. (canceled)

4. The combined LED bulb according to claim 1, characterized in that the first cover coupling section comprises snap slots and the second cover coupling section comprises snap barbs.

5. The combined LED bulb according to claim 1, characterized in that the light-transmitting cover comprises a transparent light cover.

6. The combined LED bulb according to claim 1, characterized in that the conductor a conductive shell that mates an outer configuration of the connector and is securely fit to the connector and comprises a screw thread.

7. The combined LED bulb according to claim 6, characterized in that the conductor comprises a screw thread.
